(19) United States
(12) Patent Application Publication
(10) Pub. No.: US 2025/0156970 A1
(43) Pub. Date: May 15, 2025

(54) HOTEL WIRELESS CONNECTIVITY AND SMART DEVICE CONTROL

(71) Applicant: DISH Network Technologies India Private Limited, Bengaluru (IN)

(72) Inventors: Dileep Puramana, KERALA (IN); Sreevastav Anupuru, KURNOOL (IN); Srinivasarao Duddu, BANGALORE (IN)

(21) Appl. No.: 18/392,271

(22) Filed: Dec. 21, 2023

(30) Foreign Application Priority Data
Nov. 9, 2023 (IN) 202341076749

(51) Int. Cl. H04W 12/61; G06Q 10/02; G06Q 50/12; H04W 12/77

(52) U.S. Cl. CPC G06Q 50/12; G06Q 10/02

(57) ABSTRACT

Various arrangements involving a hotel connectivity system are presented herein. A first machine-readable code indicative of a link to a webpage through which control of smart devices in a hotel room is provided. Via a display located in the hotel room, the first machine-readable code and a second machine-readable code can be presented. The second machine-readable code provides wireless network credentials. Via the webpage, the smart devices can be controlled within the hotel room. When a reservation linked to the hotel room has expired, control of the smart devices via the webpage is revoked.

### CROSS REFERENCE TO RELATED APPLICATIONS

This application claims priority to Indian Provisional Patent Application No. 202341076749, filed on Nov. 9, 2023, in the Indian Intellectual Property Office, the disclosure of which is incorporated by reference in its entirety for all purposes.

### BACKGROUND

When checking in to a hotel, a guest is typically provided with wireless network credentials by the front desk. The guest then later tries to use the credentials to access the hotel's wireless network. Frequently, this arrangement results in the user inputting a character wrong and possibly needing to contact the front desk to identify and correct the error. Further, this arrangement needs to be repeated for every device which the guest wishes to connect with the wireless network and does not allow the guest any way to communicate with smart devices that are installed or otherwise located in the hotel room.

### SUMMARY

Various embodiments are described related to a method for controlling smart devices. In some embodiments, a method for controlling smart devices is described. The method may comprise generating, by a hotel connectivity system, a first machine-readable code indicative of a link through which control of a plurality of smart devices may be performed. The plurality of smart devices may be located in a hotel room. The method may comprise outputting, via a display located in the hotel room by the hotel connectivity system, the first machine-readable code and a second machine-readable code. The second machine-readable code may provide wireless network credentials to access a wireless network. The method may comprise receiving, by the hotel connectivity system, a request to change a state of a smart device of the plurality of smart devices from a user mobile device. The method may comprise in response to the request, transmitting, by the hotel connectivity system, a command to the smart device of the plurality of smart devices. The method may comprise after transmitting the command, determining, by the hotel connectivity system, that a reservation linked to the hotel room has expired. The method may comprise in response to determining that the reservation linked to the hotel room has expired, revoking, by the hotel connectivity system, access to control the plurality of smart devices by the user mobile device.

Embodiments of such a method may include one or more of the following features: the link may refer to a webpage served locally by the hotel connectivity system and the webpage may be only accessible by the user mobile device via the wireless network. The first machine-readable code and the second machine-readable code may be quick response (QR) codes. The method may further comprise imaging, by the user mobile device, the second machine-readable code. The method may further comprise accessing, by the user mobile device, the wireless network using the wireless network credentials indicated by the second machine-readable code. The method may further comprise after accessing the wireless network, imaging the first machine-readable code. The method may further comprise requesting the link from the first machine-readable code using via the wireless network. Removing access to control the plurality of smart devices may comprise deactivating the link to the webpage. Removing access to control the plurality of smart devices may comprise revoking access to the wireless network for the user mobile device. Determining that the reservation linked to the hotel room has expired may comprise receiving a reservation end time from a hotel reservation management system in communication with the hotel connectivity system. The method may further comprise accessing, by the hotel connectivity system, a hotel smart device database. The method may further comprise retrieving, by the hotel connectivity system, data about the plurality of smart devices located in the hotel room from the hotel smart device database. The method may further comprise generating, by the hotel connectivity system, the webpage that provides control of the plurality of smart devices. The method may further comprise retrieving data about a smart device located in a hotel common area from the hotel smart device database. Generating the webpage may further provide control of the smart device located in the hotel common area.

In some embodiments, a smart device control system is described. The system may comprise a plurality of smart devices distributed in a plurality of hotel rooms of a hotel. The system may comprise the plurality of smart devices. The system may comprise a hotel connectivity system, comprising one or more processors. The hotel connectivity system may be configured to generate a first machine-readable code indicative of a link through which control of a set of smart devices may be performed. The set of smart devices may be located in a hotel room of the plurality of hotel rooms. The hotel connectivity system may be configured to output, via a display located in the hotel room, the first machine-readable code and a second machine-readable code. The second machine-readable code may provide wireless network credentials to access a wireless network. The hotel connectivity system may be configured to receive a request to change a state of a smart device of the set of smart devices from a user mobile device. The hotel connectivity system may be configured to, in response to the request, transmit a command to the smart device of the set of smart devices. The hotel connectivity system may be configured to, after transmitting the command, determine that a reservation linked to the hotel room has expired. The hotel connectivity system may be configured to, in response to determining that the reservation linked to the hotel room has expired, revoke access to control the plurality of smart devices by the user mobile device.

Embodiments of such a system may include one or more of the following features: the link refers to a webpage served locally by the hotel connectivity system and the webpage may be only accessible by the user mobile device via the wireless network. The first machine-readable code and the second machine-readable code may be quick response (QR) codes. The system may further comprise the user mobile device. The user mobile device may image the second machine-readable code. The user mobile device may access the wireless network using the wireless network credentials indicated by the second machine-readable code. The user mobile device after accessing the wireless network, may image the first machine-readable code. The user mobile device may request the link obtained from the first machine-readable code using via the wireless network. Removing access to control the set of smart devices may comprise deactivating the link to the webpage. Removing access to control the set of smart devices may comprise revoking access to the wireless network for the user mobile device. Determining that the reservation linked to the hotel room of the plurality of hotel rooms has expired may comprise receiving a reservation end time from a hotel reservation management system in communication with the hotel connectivity system. The hotel connectivity system may be further configured to access a hotel smart device database. The hotel connectivity system may be further configured to retrieve data about the plurality of smart devices located in the hotel room from the hotel smart device database. The hotel connectivity system may be further configured to generate the webpage that provides control of the plurality of smart devices. The smart device control system may further comprise a second plurality of smart devices. The second plurality of smart devices may be located in one or more common areas of the hotel. The hotel connectivity system may be further configured to retrieve data about a smart device of the second plurality of smart devices located in a hotel common area from the hotel smart device database. Generating the webpage may further provide control of the smart device of the second plurality of smart devices located in the hotel common area. The hotel connectivity system being configured to transmit the command to the smart device of the set of smart devices may comprise the hotel connectivity system transmitting the command to a smart device host system via the Internet. The smart device host system may relay the command to the smart device of the set of smart devices.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of a hotel connectivity and smart device control system.

FIG. 2 illustrates an embodiment of a hotel room utilizing a hotel connectivity and smart device control system.

FIG. 3A illustrates an embodiment of a webpage through which hotel smart devices are controlled.

FIG. 3B illustrates an embodiment of a webpage through which a set top box (STB) is controlled.

FIG. 4 illustrates an embodiment of a database mapping hotel locations to smart devices available for control.

FIG. 5 illustrates an embodiment of a method for connecting a device to a hotel's wireless network and controlling smart devices linked to a hotel room.

### DETAILED DESCRIPTION

Arrangements detailed herein are directed to methods and systems that can be used with a hotel room or any other place where connection to a wireless network and temporary control of smart home devices is useful. For an embodiment involving a hotel, following check-in, a display, such as a television, within the hotel room may be used to present multiple on-screen machine-readable codes. These machine-readable codes may be quick response (QR) codes that can be read by a computerized mobile device by capturing an image of the QR code. A QR code can be used to provide the mobile device with an identifier (e.g., SSID) and passcode for accessing the wireless network. A guest may image the QR code and use the information contained therein to connect with the wireless network.

Another QR code may also be present. This QR code can be used to grant access to control one or more smart devices located within the hotel room (and, possibly, within common areas of the hotel). By imaging this QR code, the mobile device is provided with a link to access a webpage (or other form of resource, such as an application) that allows for control of smart devices within the hotel room. As an example, the webpage can allow for control of: the television, one or more lights, an audio device, an alarm, a fan, an HVAC (heating, ventilation, and air conditioning) system, etc. Notably, rather than requiring an application to be installed, use of a webpage may be specifically used to allow for the controls to be directly loaded by the user accessing the link indicated by the second QR code.

A hotel booking system can be used to control access to the wireless network and/or the smart devices. Once a guest's check-out time has been reached (or the guest has checked out at the front desk), access to the smart devices and wireless network can be deactivated. To do so, the link used to access the webpage and perform the control may no longer be valid or accessible (with future guests being provided an updated link to the same or a newly generated webpage). Further, all devices associated with the hotel room joined to the wireless network may be revoked from access. The webpage to control the smart home devices may only be accessible locally through the wireless network, therefore preventing revoked devices from accessing, even if the webpage's address remains valid.

While the embodiments detailed herein are focused on hotels (and other forms of lodging, such as motels, long-term stay residences, etc.), the arrangements can be applied to other locations and situations where a user is to be granted temporary access to control smart devices. For example, a similar arrangement could be used to allow a babysitter or house sitter to access smart devices in a home. A similar arrangement could be used in an office for smart device control by employees and/or visitors.

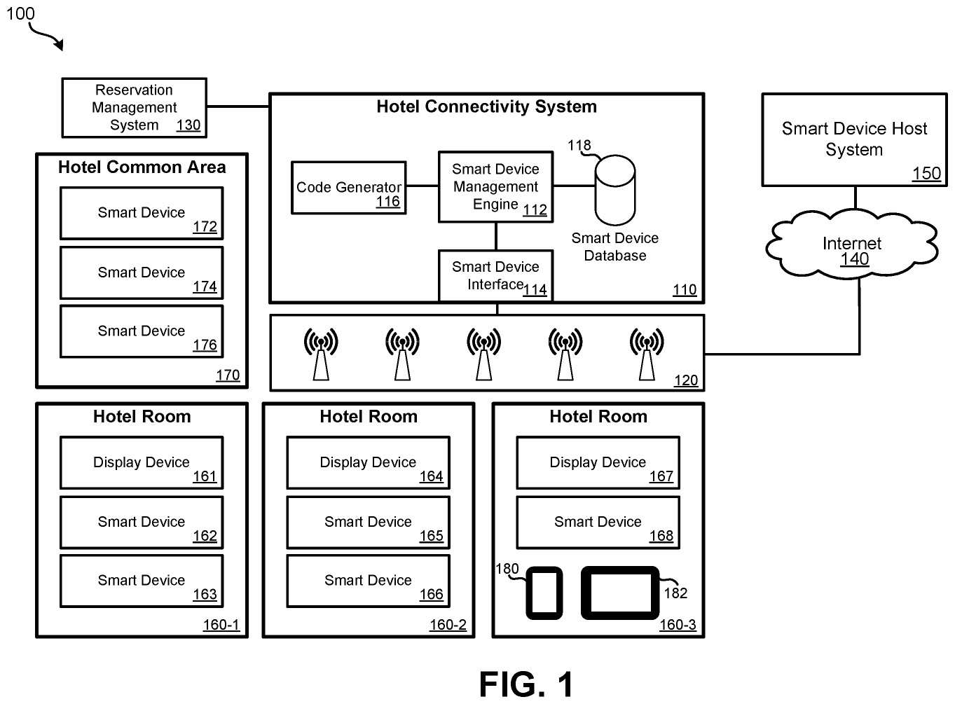

Further detail regarding these embodiments and additional embodiments is provided in relation to the figures. FIG. 1 illustrates a block diagram of an embodiment of a connectivity and smart device control system 100 (“system 100”). System 100 can include: hotel connectivity system 110, access points (APs) 120, reservation management system 130, Internet 140, smart device host system 150, devices within hotel rooms 160 (e.g., 160-1, 160-2, 160-3), and devices within hotel common area 170.

Hotel connectivity system 110 can be implemented using one or more server systems performing processes located locally at a hotel or hosted remotely. In some embodiments, some or all of the functionality of hotel connectivity system 110 can be implemented using a public cloud service provider system, such as Amazon Web Services (AWS). Whether implemented locally or remotely, hotel connectivity system 110 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random-access memory (RAM), flash memory, a hard disk drive (HDD), or a solid state drive (SSD).

Hotel connectivity system 110 can include various components that are performed by executed software. These components can include: smart device management engine 112, smart device interface 114, code generator 116, and smart device database 118. Smart device management engine 112 may be responsible for determining which smart devices a user device should have access to control, causing machine-readable codes to be presented in the appropriate hotel rooms, and revoking access to controlling smart devices once a reservation for a hotel room is complete.

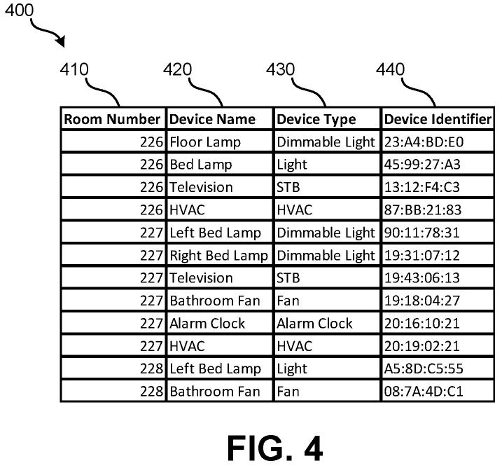

Smart device management engine 112 may create a webpage that allows for control of all smart devices present within a given hotel room. Smart device management engine 112 may access smart device database 118 to determine the smart devices that are available to be controlled within a given hotel room. An example of information that may be stored in smart device database 118 is provided in relation to FIG. 4. Smart device management engine 112 may then provide a link to a generated webpage specific for a hotel room. Code generator 116 can create a machine-readable code, such as a quick response code, that encodes the link within the machine-readable code. Smart device management engine 112 can then use smart device interface 114 to cause the machine-readable code to be presented on a display device located within the corresponding hotel room. In some embodiments, the machine-readable code is caused to be presented in response to a message from reservation management system 130 that indicates a guest corresponding to the hotel room has checked in.

Reservation management system 130 can refer to a system through which hotel staff manages reservations for a hotel. Reservation management system 130 may store information related to the start and end date and time of reservations for given hotel rooms. Therefore, when a reservation begins or ends, reservation management system 130 can transmit an indication of the corresponding hotel room and an indication of the reservation to smart device management engine 112.

One or more APs 120 can be located throughout the hotel in order to provide wireless network access to user mobile devices and smart devices. In some embodiments, at least some devices may use a wired connection to APs. APs 120 can allow for access to Internet 140 and for communication with hotel connectivity system 110 via smart device interface 114.

By way of example only, three hotel rooms are represented in FIG. 1. Hotel room 160-1 includes display device 161, smart device 162, and smart device 163. Hotel room 160-2 includes display device 164, smart device 165, and smart device 166. Hotel room 160-3 is occupied by a guest and includes display device 167, smart device 168, user mobile device 180, and user mobile device 182.

Display devices, such as display device 161, display device 164, and display device 167 can be smart televisions and/or televisions that are connected with smart set top boxes (STBs); therefore, these display devices, either with or without an STB, can be understood to be smart devices that communicate with hotel connectivity system 110. Smart devices 162, 164, 165, 166, and 168 can be various forms of smart devices that might be installed in hotel rooms and for which control by a guest is desirable. Such smart devices can include: lights, lamps, fans, smart alarm clocks, HVAC systems (e.g., a smart thermostat), music systems, audio assistant devices, smart window coverings, etc. There may be multiple smart devices of a same type in a hotel room, such as multiple smart lights. Smart devices of a same type, may be able to be controlled independently or as a group.

In some embodiments, one or more smart devices may also be available for control by a guest within a hotel common area, such as hotel common area 170. After a guest has registered to control smart devices within the guest's hotel room, the guest may also be permitted to control particular smart devices within hotel common area 170. For example, hotel common area 170 may be a fitness room. As an example, three smart devices are shown in hotel common area 170: smart device 172, smart device 174, smart device 176. As an example, these smart devices may be televisions which the user may wish to control while working out. In some embodiments, a guest is only permitted to control such smart devices when the guest is determined to be in the vicinity of hotel common area 170. For example, the user's mobile device may be required to be in communication with the particular access point of APs 120, which can be used as a proxy that the user's mobile device is located within hotel common area 170. Multiple guests may be permitted to control smart devices located in hotel common area 170 during the same time period. Therefore, if a first guest sets smart device 172 to a particular television channel, a second guest can be permitted to change smart device 172 to another television channel. In other embodiments, once a particular smart device is controlled by a guest, other guests may be locked out from controlling the particular smart device for a predefined period of time (e.g., 15 minutes).

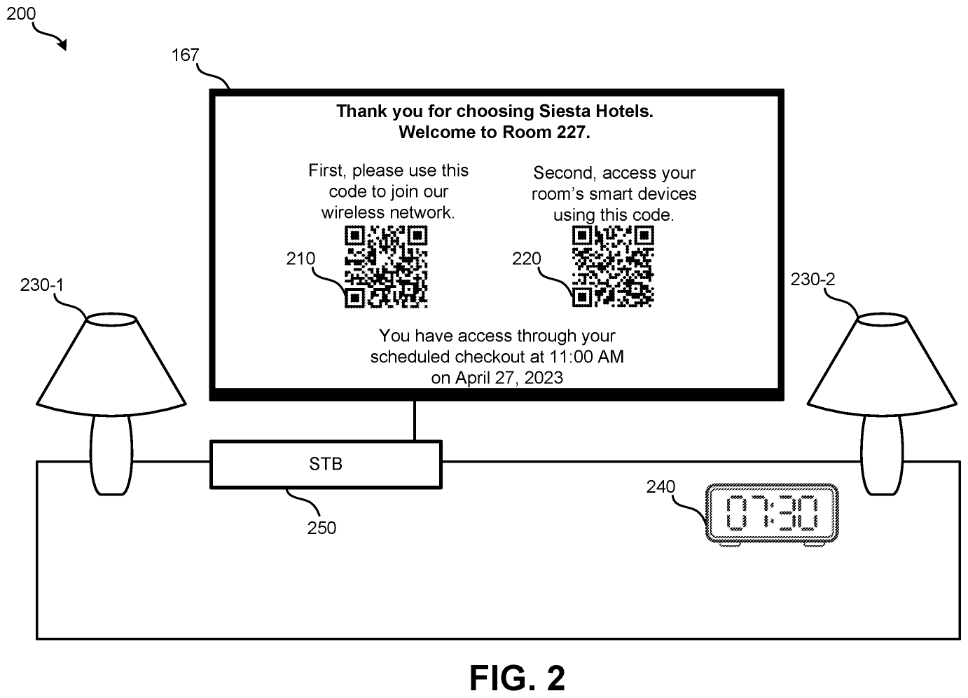

In hotel room 160-3, two user devices are present: user mobile device 180 and user mobile device 182. As an example, user mobile device 180 may be a smartphone and user mobile device 182 may be a tablet computer, gaming device, or laptop computer. Two mobile user devices are shown by way of example only. Detail of how such user mobile devices can be registered for network access and used to control smart devices is detailed in relation to FIG. 2.

FIG. 2 illustrates an embodiment of a hotel room 200 utilizing a connectivity and smart device control system. Hotel room 200 can represent an embodiment of hotel room 160-3. Upon arriving, a user can be presented with two machine-readable codes (e.g., QR codes). In some embodiments, display device 167 (e.g., smart television) communicates directly with hotel connectivity system 110; in other embodiments, a set top box communicates with hotel connectivity system 110 and outputs content for presentation to display device 167.

Machine-readable code 210 can be imaged using a camera of a user mobile device. The user mobile device, such as user mobile device 180, can decode machine-readable code 210 in order to determine wireless network credentials, such as a service set identifier and a passcode, which can be used to connect to the wireless network hosted using APs 120. Connecting to the wireless network hosted using APs 120 may be a prerequisite before using machine-readable code 220. That is, access to control smart devices may only be permitted if the user mobile device is connected with the wireless network hosted using APs 120. Alternatively, rather than using machine-readable code 210, a user may be permitted to manually enter wireless network credentials. Such an arrangement may be particularly useful if the user mobile device does not have a camera capable of imaging the machine-readable code 210.

After connecting with the wireless network, the user mobile device may be used to image machine-readable code 220. A link, such as a link to a webpage, can be encoded into machine-readable code 220. When imaged by the user mobile device, the user mobile device may have the option of opening a link in a browser. This link directs the browser to access a webpage generated specifically for hotel room 200 that allows the guest to control smart devices located within hotel room 200. As an example, these smart devices could include: smart lamp 230-1, smart lamp 230-2, and smart alarm clock 240. Additionally, display device 167 or STB 250 can be understood to be a smart device that is controllable via the webpage from the link of machine-readable code 220.

The link embedded in machine-readable code 220 may be static or dynamic. A dynamic link is a link that is specific to the guest's reservation, with a different link used for future and past guests of the same hotel room. In other embodiments, a static link may be used. The static link may stay the same for every guest of a particular hotel room but can require the guest supply additional credentials when accessing the link, such as accessing the link for the first time from a given mobile device. For example, in response to requesting the link, the guest may be requested to provide his or her name, his room number, a reservation number, an email address, check-out information, and/or a code or passcode. The guest may also be required to agree to terms and conditions in order to be permitted to control smart devices. If the guest's information and/or reservation is validated by the hotel connectivity system and reservation management system, in some embodiments, a cookie gets created or updated on the guest's device that allows for continued access to webpage (e.g., via autologin), such as without needing to provide the same guest information again, through the end of the guest's reservation. After the reservation, the cookie may expire, causing the guest information to be requested again. If the guest attempts to submit his or her information again, access may be denied because the guest is determined by the hotel connectivity system and reservation management system to no longer be linked to a valid, active reservation.

When a smart device is controlled via the linked webpage, a message is sent from the user mobile device via APs 120 and smart device interface 114 smart device management engine 112. Smart device management engine 112 may confirm that the user mobile device is authorized to control the smart device, such as by confirming that the user mobile device is connected with the hotel's wireless network and/or the location of the user mobile device is proximate to the user's hotel room. In some embodiments, smart device management engine 112 may send a command directly to the smart device to be controlled. For example, if the message indicates that a channel is to be changed on display device 167, a command indicating the channel change may be transmitted by smart device management engine 112 via smart device interface 114 and APs 120 to display device 167. In response, display device 167 may change the television channel.

In some embodiments, commands to a smart device may need to be transmitted via smart device host system 150. Smart device host system 150 may be operated by a manufacturer or vendor of the smart device. In such embodiments, when a user mobile device sends a message to smart device management engine 112 via the webpage, if authorized, smart device management engine 112 may send a request (e.g., via an application programming interface, API) to smart device host system 150 via Internet 140. In response, smart device host system 150 may transmit a command message to the corresponding smart device attempting to be controlled. A mix of smart devices may be present in a hotel room. Therefore, for example, display device 167 (which can include an STB) may receive commands directly from smart device management engine 112, while another smart device, such as a smart light bulb, may receive commands from smart device host system 150. Separate smart device host systems 150 may be present for different manufacturers or vendors of smart devices.

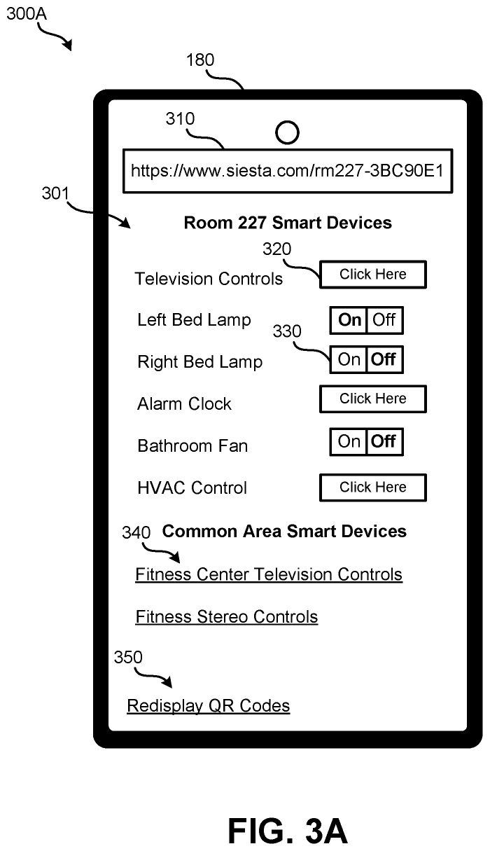

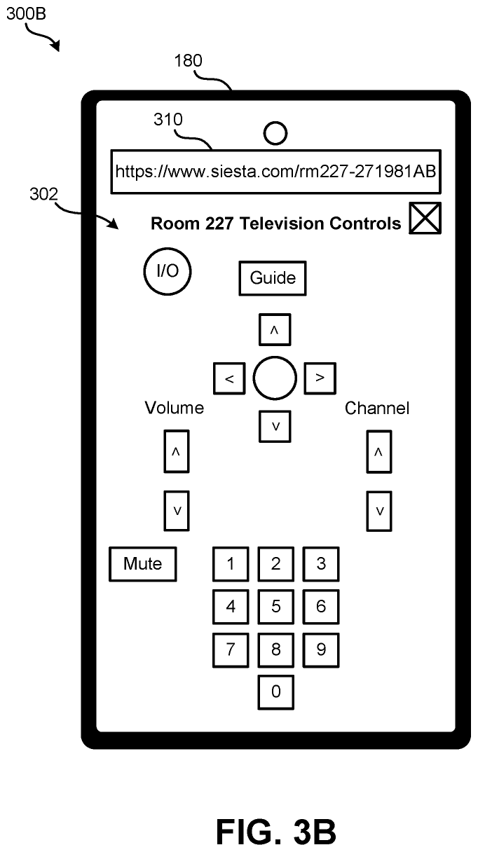

FIG. 3A illustrates an embodiment 300A of a webpage through which hotel smart devices are controlled. For clarity, the term “webpage” is intended to refer to a document that can be loaded and displayed in any browser, typically using HTML as the coding language. Other arrangements, such as using Java, may be possible. In embodiment 300A, webpage 301, accessed by imaging machine-readable code 220, is presented by user mobile device 180. As seen in address bar 310, the link from machine-readable code 220 causes a webpage specific to the hotel room in which the user is staying to be retrieved. Webpage 301 allows for control of the smart devices located within the hotel room. The layout of webpage 301 is merely exemplary. In some embodiments, controls for a smart device are directly accessible on webpage 301, such as element 330 for the right bed lamp. Touching or otherwise selecting on or off causes a request indicative of the device and desired state, such as in the form of a link, to be transmitted to hotel connectivity system 110. In some embodiments, such as for smart devices with a significant number of controls, an element may be selected, such as element 320, that requests, via a link, another webpage through which the controls for the smart device can be accessed. For example, if a user selects element 320, webpage 302 of FIG. 3B may be loaded.

In some embodiments, either directly or through a link to another webpage, smart devices in other areas of the hotel may be controlled. For example, links to separate webpages for common area smart device 340 are provided on webpage 301. Selecting one of these links may cause another webpage to be loaded specific to the smart devices of the selected location.

Frequently, a user desires to have multiple user mobile devices connected to a hotel wireless network and, possibly, used to control smart devices. On webpage 301, link 350 may be used to request and display machine-readable codes to allow another device to connect to the wireless network and/or access a webpage to control smart devices in the hotel room and, possibly, common areas.

FIG. 3B illustrates an embodiment 300B of a webpage 302 through which a set top box (STB) is controlled. The controls for the STB may be presented on the display screen of user mobile device 180 in response to the link indicated in address bar 310 being loaded. Whenever an element is touched by the user, an indication of the element may be transmitted to smart device management engine 112. The specific STB controls and layout shown on webpage 302 are mere examples. A similar interface could be used for a smart television or other form of smart display.

While the embodiments detailed herein are focused on webpages, in other embodiments, it may be possible to require the guest to download and install a specific application that provides similar functionality on user mobile device 180. For example, rather than having machine-readable code 220 have an embedded link to a webpage specific to the hotel room, the link may direct the user to download a particular application from an app store.

FIG. 4 illustrates an embodiment of a portion of a smart device database 400 mapping hotel locations to smart devices available for control. Smart device database 400 can represent an embodiment of smart device database 118 of FIG. 1. In the portion of smart device database 400 illustrated, a mapping of room numbers 410 to device names 420, device types 430, and device identifiers 440 may be present. When a webpage or group of webpages is generated, room number 410 may be used to determine which smart devices should be included. Device name 420 can be used to identify the smart device on the webpage. Device type 430 may be used to select the elements that are to be included on the webpage to be used by the guest to control the smart device. Device identifier 440 may be used to address or otherwise communicate with the smart device.

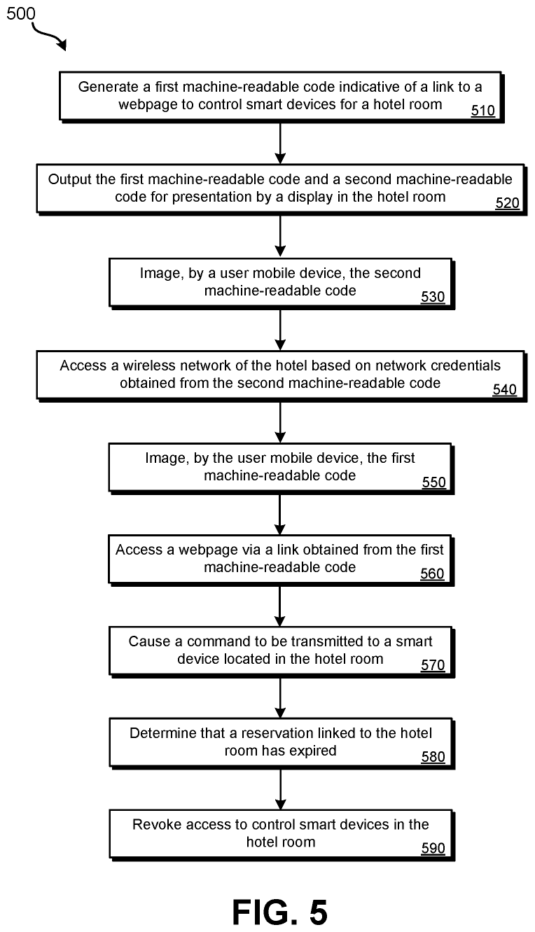

Various methods may be performed in relation to the systems and devices detailed in relation to FIGS. 1-4. FIG. 5 illustrates an embodiment of a method 500 for connecting a user mobile device to a hotel's wireless network and controlling smart devices linked to the user's hotel room. Method 500 can be performed using system 100 of FIG. 1. Specifically, blocks of method 500 can be performed by hotel connectivity system 110, regardless of whether hosted on-site (e.g., at a hotel), remotely, or in the cloud. Other blocks, as indicated, can be performed using a user mobile device.

At block 510, a first machine-readable code indicative of a link to a webpage to control smart devices for a hotel room may be generated. The first machine-readable code can encode a link to a webpage that is used for only one reservation. That is, for future reservations in the same hotel room, a new link may be generated and all old links to the webpage may be disabled. The smart devices controllable on the webpage can be based on the smart devices linked to the room in a smart device database, such as detailed in relation to FIG. 4. The link generated to the webpage may only be valid when accessed from the hotel's guest wireless network. That is, access to the webpage via the Internet is blocked.

At block 520, the first machine-readable code and a second machine-readable code are output for presentation by a display in a hotel room. The second machine-readable code is encoded to include wireless network credentials, such as an SSID and passcode, for a guest wireless network of the hotel. This second machine-readable code may not need to be newly generated new for each reservation. Rather, since the SSID and passcode do not change per guest, the second machine-readable code may be generated once and used for many reservations. Alternatively, the second machine-readable code can be generated using credentials that are particular to a reservation, thus allowing the credentials to be easily revoked at the end of the reservation. As part of block 520, the first machine-readable code is transmitted to the display device that presents the machine-readable codes by the hotel connectivity system. At block 520, the first and second machine-readable codes can be presented, possibly simultaneously, by the display device. When a guest checks in at a hotel's front desk, the reservation management system may trigger the display device to present the machine-readable codes such that they are on-screen when the guest arrives in his or her room. In some embodiments, the reservation management system triggers block 510 in response to the user checking-in to the hotel.

At block 530, a user mobile device, such as a smartphone, is used to image the second machine-readable code being presented by the display device. When a camera application or code scanning application (e.g., a QR scanning application) is activated on the user mobile device and the camera of the user mobile device is pointed at the second-machine readable code, the guest may be prompted with an option to activate wireless network credentials. For a WiFi network, these wireless network credentials can include an SSID and passcode. If the guest's user mobile device does not have a camera, the guest may have the option of manually entering wireless network credentials. In some embodiments, since the second machine-readable code may be static for multiple hotel rooms and guests, the second machine-readable code may be presented in an additional or alternate location, such as on paper.

At block 540, access to the wireless network of the hotel is realized using the network credentials obtained from the second machine-readable code. The user's mobile device connects to the hotel wireless network using the wireless network credentials of block 530. Once connected, the guest may be required to agree to various terms and conditions and/or provide basic information, such as the guest's room number and name in order to be granted network access, which can include Internet access.

At block 550, the user mobile device, which is now connected to the wireless network of the hotel, can next be used to image the first machine-readable code. The network-connected user mobile device is next used to image the first machine-readable code being presented by the display device. When a camera application or code scanning application (e.g., a QR scanning application) is activated on the user mobile device and the camera of the user mobile device is pointed at the first machine-readable code, the guest may be prompted with an option to open a link. This link directs the user mobile device to a webpage that is linked to the guest's hotel room. This link may be generated specifically for the guest's reservation and therefore may not be a valid link before the guest's reservation begins or after the guest's reservation ends.

At block 560, a webpage for which a link was decoded from the first machine-readable code is accessed by the user mobile device. The webpage may only be accessible via the hotel's wireless network. Therefore, if the user mobile device is not connected with the wireless network of the second machine-readable code, access to the webpage may be denied or otherwise unavailable. If connected with the wireless network, the webpage may be delivered to the user mobile device by the hotel connectivity system based on the requested link. The webpage can include: 1) smart devices available for control within the guest's hotel room; and, possibly, 2) smart devices available for control within common areas of the hotel room. FIGS. 3A and 3B illustrate example webpages corresponding to a particular hotel room.

In some embodiments, the hotel connectivity system retrieves a stored webpage to be provided in response to the requested link. In other embodiments, the webpage is generated in response to the link being requested. If generated in response, to create the webpage, the hotel connectivity system may retrieve a list of available smart devices for the hotel room from a smart device database and generate smart device controls and, possibly additional webpages based on the smart devices available for the hotel room and the common areas. Stored webpages may be generated similarly or may have been created according to some other arrangement, such as manually.

As indicated in relation to FIGS. 3A and 3B, various additional webpages may be used. For example, from webpage 301, a user may desire to control a smart television or smart STB. To do so, a dedicated webpage may be requested via element 320.

At block 570, a command is caused to be transmitted to a smart device located in the hotel room. Block 570 can include multiple steps. Using the webpage received at block 560, the user may select an action associated with a smart device. By way of example only, the guest may desire to turn on a lamp located to the right of the hotel room's bed using element 330. In response to selecting “on,” the browser may cause a link to be requested by (or, more generally, may cause information to be transmitted to) the hotel connectivity system. The hotel connectivity system receives the request, determines whether it was authorized (e.g., the request originated from on the hotel's wireless network), and, if authorized, in response, transmits a command to the smart device that causes it to perform the action indicated in the request. As previously detailed, the hotel connectivity system may alternatively send the command to a third-party smart device host system that manages all commands for a given smart device. In response to the command from either the hotel connectivity system or the smart device host system, the smart device performs the command (in this example, the right bed lamp turns on). The webpage may be updated by the hotel connectivity system to reflect the new status of the right bed lamp. Blocks 560 and 570 may be repeated many times during the guest's reservation to control the same or different smart devices in the hotel room and/or in hotel common areas.

At block 580, a reservation linked to the hotel room is determined to have expired. Block 580 can include and be based on a message being transmitted to and received by the hotel connectivity system from a reservation management system indicative of a reservation linked to the hotel room ending. In some embodiments, when block 510 was initially triggered, a reservation end time/date may have also been included.

At block 590, access to control the smart devices and/or access to the wireless network of the hotel is revoked, such as in response to the reservation's end time/date from block 580. Revocation can be performed in multiple ways. Revocation can include the link that is used to access the webpage for the hotel room being deactivated such that when requested, no webpage is provided in response. Revocation can include the user mobile device being denied access to the hotel's wireless network. Revocation can include that when a request is made via the webpage, the hotel connectivity system determines that the check-out date/time has been reached and the guest is no longer authorized to control any hotel room or hotel common area smart devices. In such embodiments, the request may be ignored by the hotel connectivity system and, possibly, a response is sent that indicates denial of access.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for controlling smart devices, the method comprising:
generating, by a hotel connectivity system, a first machine-readable code indicative of a link through which control of a plurality of smart devices is performed, wherein the plurality of smart devices is located in a hotel room;
outputting, via a display located in the hotel room by the hotel connectivity system, the first machine-readable code and a second machine-readable code, wherein the second machine-readable code provides wireless network credentials to access a wireless network;
receiving, by the hotel connectivity system, a request to change a state of a smart device of the plurality of smart devices from a user mobile device;
in response to the request, transmitting, by the hotel connectivity system, a command to the smart device of the plurality of smart devices;
after transmitting the command, determining, by the hotel connectivity system, that a reservation linked to the hotel room has expired; and
in response to determining that the reservation linked to the hotel room has expired, revoking, by the hotel connectivity system, access to control the plurality of smart devices by the user mobile device.

2. The method for controlling the smart devices of claim 1, wherein the link refers to a webpage served locally by the hotel connectivity system and the webpage is only accessible by the user mobile device via the wireless network.

3. The method for controlling the smart devices of claim 2, wherein the first machine-readable code and the second machine-readable code are quick response (QR) codes.

4. The method for controlling the smart devices of claim 2, further comprising:
imaging, by the user mobile device, the second machine-readable code;
accessing, by the user mobile device, the wireless network using the wireless network credentials indicated by the second machine-readable code;
after accessing the wireless network, imaging the first machine-readable code; and
requesting the link from the first machine-readable code using via the wireless network.

5. The method for controlling the smart devices of claim 2, wherein removing access to control the plurality of smart devices comprises deactivating the link to the webpage.

6. The method for controlling the smart devices of claim 1, wherein removing access to control the plurality of smart devices comprises revoking access to the wireless network for the user mobile device.

7. The method for controlling the smart devices of claim 1, wherein determining that the reservation linked to the hotel room has expired comprises receiving a reservation end time from a hotel reservation management system in communication with the hotel connectivity system.

8. The method for controlling the smart devices of claim 2, further comprising:
accessing, by the hotel connectivity system, a hotel smart device database;
retrieving, by the hotel connectivity system, data about the plurality of smart devices located in the hotel room from the hotel smart device database; and
generating, by the hotel connectivity system, the webpage that provides control of the plurality of smart devices.

9. The method for controlling the smart devices of claim 8, further comprising:
retrieving data about a smart device located in a hotel common area from the hotel smart device database, wherein generating the webpage further provides control of the smart device located in the hotel common area.

10. A smart device control system, comprising:
a plurality of smart devices distributed in a plurality of hotel rooms of a hotel, wherein the plurality of smart devices; and
a hotel connectivity system, comprising one or more processors, wherein the hotel connectivity system is configured to:
generate a first machine-readable code indicative of a link through which control of a set of smart devices is performed, wherein the set of smart devices is located in a hotel room of the plurality of hotel rooms;
output, via a display located in the hotel room, the first machine-readable code and a second machine-readable code, wherein the second machine-readable code provides wireless network credentials to access a wireless network;
receive a request to change a state of a smart device of the set of smart devices from a user mobile device;
in response to the request, transmit a command to the smart device of the set of smart devices;
after transmitting the command, determine that a reservation linked to the hotel room has expired; and
in response to determining that the reservation linked to the hotel room has expired, revoke access to control the plurality of smart devices by the user mobile device.

11. The smart device control system of claim 10, wherein the link refers to a webpage served locally by the hotel connectivity system and the webpage is only accessible by the user mobile device via the wireless network.

12. The smart device control system of claim 11, wherein the first machine-readable code and the second machine-readable code are quick response (QR) codes.

13. The smart device control system of claim 11, further comprising the user mobile device, wherein the user mobile device:
images the second machine-readable code;
accesses the wireless network using the wireless network credentials indicated by the second machine-readable code;
after accessing the wireless network, images the first machine-readable code; and
requests the link obtained from the first machine-readable code using via the wireless network.

14. The smart device control system of claim 11, wherein removing access to control the set of smart devices comprises deactivating the link to the webpage.

15. The smart device control system of claim 10, wherein removing access to control the set of smart devices comprises revoking access to the wireless network for the user mobile device.

16. The smart device control system of claim 10, wherein determining that the reservation linked to the hotel room of the plurality of hotel rooms has expired comprises receiving a reservation end time from a hotel reservation management system in communication with the hotel connectivity system.

17. The smart device control system of claim 11, wherein the hotel connectivity system is further configured to:
access a hotel smart device database;
retrieve data about the plurality of smart devices located in the hotel room from the hotel smart device database; and
generate the webpage that provides control of the plurality of smart devices.

18. The smart device control system of claim 17, further comprising: a second plurality of smart devices, wherein the second plurality of smart devices are located in one or more common areas of the hotel.

19. The smart device control system of claim 18, wherein the hotel connectivity system is further configured to:
retrieve data about a smart device of the second plurality of smart devices located in a hotel common area from the hotel smart device database, wherein generating the webpage further provides control of the smart device of the second plurality of smart devices located in the hotel common area.

20. The smart device control system of claim 10, wherein the hotel connectivity system being configured to transmit the command to the smart device of the set of smart devices comprises the hotel connectivity system transmitting the command to a smart device host system via the Internet, wherein the smart device host system relays the command to the smart device of the set of smart devices.
